(19) United States
(12) Patent Application Publication
(10) Pub. No.: US 2017/0048117 A1
(43) Pub. Date: Feb. 16, 2017

(54) INFORMATION PROCESSING DEVICE AND METHOD OF DISPLAYING DOWNLOAD PROGRESS STATE

(71) Applicant: Sony Interactive Entertainment Inc., Tokyo (JP)

(72) Inventors: Akitsugu TSUCHIYA, Kanagawa (JP); Masaki TAKAHASHI, Kanagawa (JP); Syunsuke BAMBA, Tokyo (JP)

(21) Appl. No.: 15/201,880

(22) Filed: Jul. 5, 2016

(30) Foreign Application Priority Data
Aug. 10, 2015 (JP) 2015-158432

(51) Int. Cl. H04L 12/26; G06F 3/0484; G06F 3/0481; H04L 29/06

(52) U.S. Cl. CPC H04L 43/045; H04L 43/0894; H04L 67/42; G06F 3/04842; G06F 3/0481

(57) ABSTRACT

Disclosed herein is an information processing device including a download executing section downloading application software and patch data, a progress state display section displaying a progress state of the downloading, and an executing section executing an application by using the application software and the patch data, the progress state display section displaying the progress state of the downloading of a combined total of the application software and the patch data.

### BACKGROUND

The present technology relates to an information processing technology performed in an information processing device such as a game device or the like.

In the past, game software has been distributed and sold in a form of read only memory (ROM) media such as an optical disk, a magneto-optical disk, and a Blu-ray Disk. With increases in speed of data communications, servers have recently become able to distribute the image files of game software via the Internet.

Game software includes a startup file, a resource file group for executing a game such as a game program, and a file group used by the operating system (OS) of a game device. In recent years, the number of files included in the game software tends to be increased, and the data size of the game software tends to be increased.

U.S. Patent Application Publication No. 2014/201209 (hereinafter referred to as Patent Document 1) discloses a group structure in which game software is divided into a plurality of groups, and one group (first group) of the plurality of groups is configured such that program files and data files necessary to start the game software belong to the group (first group). According to the technology disclosed in Patent Document 1, when a download of all of files belonging to the first group is completed, the game software can be started without download of files of a following second group and subsequent groups. The files belonging to the second and subsequent groups can be downloaded in the background while a user is playing a game. This shortens a download waiting time of the user which waiting time is taken before the game is started.

### SUMMARY

A problem of how to present a download progress state to a user arises in the case where game software is divided into a plurality of groups and is then downloaded on a group-by-group basis, as disclosed in Patent Document 1. In recent years, in particular, it has been common practice to apply a patch to game software to correct or add a scenario. When a case of simultaneously downloading patch data together with game software is assumed, it is desirable to be able to present a download progress state such that a user can intuitively recognize the download progress state. Incidentally, without being limited to cases of performing download in group units as disclosed in Patent Document 1, it is desirable that a download progress state can be effectively presented to a user in cases of simultaneously downloading patch data together with game software.

It is accordingly desirable to provide a technology of effectively presenting a download progress state.

According to a mode of the present technology, there is provided an information processing device including a download executing section downloading application software and patch data, a progress state display section displaying a state of progress of the downloading, and an executing section executing an application by using the application software and the patch data. The progress state display section displays the state of progress of the downloading of a combined total of the application software and the patch data.

Another mode of the present technology relates to a method of displaying a download progress state. This method includes downloading application software and patch data, and displaying a state of progress of the downloading of a combined total of the application software and the patch data.

It is to be noted that arbitrary combinations of the above constituent elements as well as modes realized by converting expressions of the present technology between a method, a device, a system, a recording medium, and a computer program are also effective as modes of the present technology.

According to the information processing technology in accordance with the present technology, it is possible to provide a technology of presenting the downloading progress state efficiently.

### BRIEF DESCRIPTION OF THE DRAWINGS

FIG. 1 is a diagram depicting an information processing system according to an embodiment of the present technology;

FIG. 2 is a diagram depicting functional blocks of an information processing device;

FIG. 3 is a conceptual diagram of a file configuration of game software;

FIG. 4 is a diagram depicting a concrete example of the file configuration of the game software;

FIG. 5 is a diagram depicting an example of relation between groups and files;

FIG. 6 is a diagram depicting an example of a group file;

FIG. 7 is a diagram depicting relation between the game software and patch data;

FIG. 8 is a diagram depicting functional blocks for performing download processing in an information processing device;

FIG. 9 is a diagram depicting an example of a home screen;

FIG. 10 is a diagram depicting an example of a download confirmation screen;

FIG. 11 is a diagram depicting an example of the download confirmation screen;

FIG. 12 is a diagram depicting an example of the download confirmation screen;

FIG. 13 is a diagram depicting an example of the download confirmation screen;

FIG. 14 is a diagram depicting an example of the download confirmation screen;

FIG. 15 is a diagram depicting an example of the download confirmation screen;

FIG. 16 is a diagram depicting an example of the download confirmation screen; and

FIG. 17 is a diagram depicting an example of the download confirmation screen.

### DETAILED DESCRIPTION OF THE PREFERRED EMBODIMENT

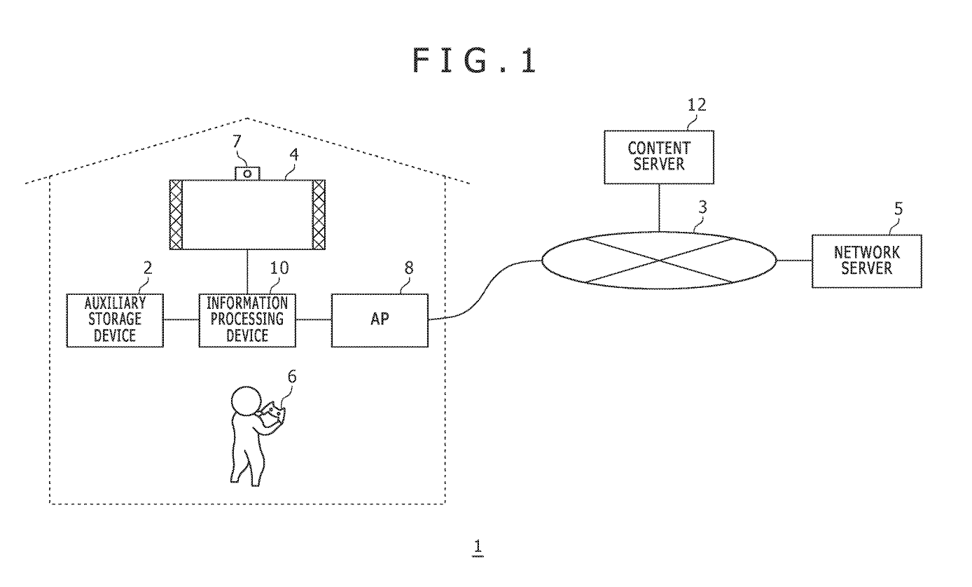

FIG. 1 depicts an information processing system 1 according to an embodiment of the present technology. The information processing system 1 includes an information processing device 10, a network server 5, and a content server 12 that distributes digital content. The information processing device 10, the network server 5, and the content server 12 are connected to one another via a network 3 such as the Internet and a local area network (LAN). The content server 12 retains digital content such as game software and patch data of the game, and distributes the digital content to the information processing device 10.

An access point (hereinafter referred to as an “AP”) 8 has functions of a wireless access point and a router. The information processing device 10 is connected to the AP 8 via radio or wire, and is thus connected to the network server 5 and the content server 12 on the network 3 in such a manner as to be able to communicate with the network server 5 and the content server 12.

The information processing device 10 is connected to an input device 6 operated by a user by radio or wire. The input device 6 outputs operation information indicating a result of operation by the user to the information processing device 10. When receiving the operation information from the input device 6, the information processing device 10 reflects the operation information in processing of OS (system software) or game software, and makes a result of the processing output from an output device 4. In the information processing system 1, the information processing device 10 may be a terminal device such as a game device for executing game software and a personal computer. The input device 6 may be a device for supplying the user operation information to the information processing device 10, such as a game controller. The user can operate the OS and the game software by logging in to the OS of the information processing device 10.

The network server 5 is maintained and managed by an entity that operates the information processing system 1. The network server 5 provides the network service to the user of the information processing system 1. The network server 5 manages a network account identifying the user. The user signs in to the network service provided by the network server 5 using the network account. By signing in to the network service from the information processing device 10, the user can receive the digital content distributed from the content server 12. Incidentally, the content server 12 may be provided with the user managing function of the network server 5. In the embodiment, the digital content may be various kinds of application software and various kinds of patch data of the applications. In the following, however, description will be made of a case in particular where the digital content are game software and patch data of the game.

An auxiliary storage device 2 is a mass storage device such as a hard disk drive (HDD) and a flash memory. The auxiliary storage device 2 may be an external storage device connected to the information processing device 10 by a universal serial bus (USB), or may be an internal storage device. The output device 4 may be a television set including a display for outputting an image and a speaker for outputting sound, or may be a computer display. The output device 4 may be connected to the information processing device 10 by a wire cable, or may be connected to the information processing device 10 by radio.

The input device 6 includes a plurality of input portions such as a plurality of push type operating buttons, an analog stick allowing an analog quantity to be input, and a rotation type button. A camera 7 as an imaging device is provided in the vicinity of the output device 4. The camera 7 images a space around the output device 4. FIG. 1 depicts an example in which the camera 7 is attached to an upper portion of the output device 4. However, the camera 7 may be disposed on the side of the output device 4. In either case, the camera 7 is disposed in such a position as to be able to image the user playing a game in front of the output device 4. The camera 7 may be a stereo camera. The information processing device 10 has a function of performing face authentication of the user from an image imaged by the camera 7, and logging the user in.

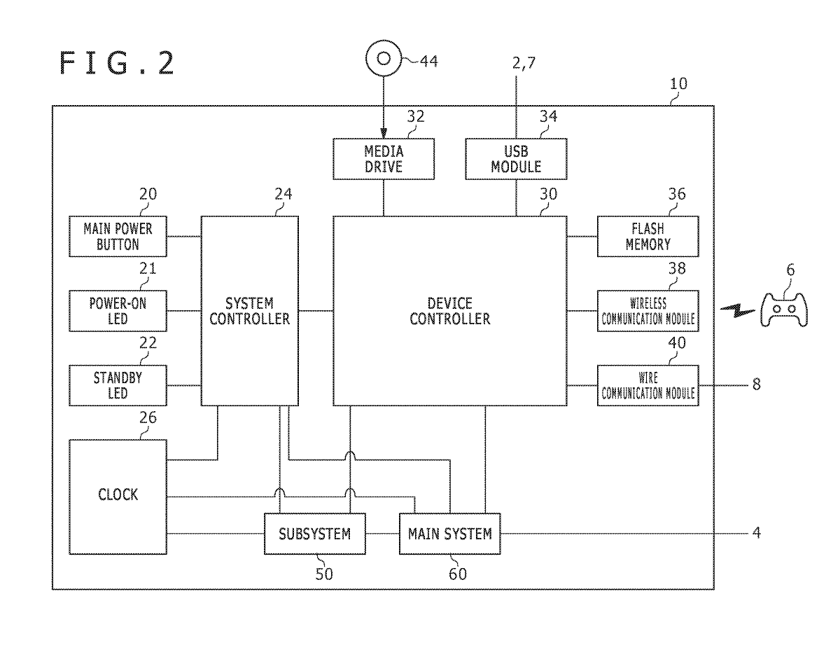

FIG. 2 is a functional block diagram of the information processing device 10. The information processing device 10 includes a main power supply button 20, a power-on light-emitting diode (LED) 21, a standby LED 22, a system controller 24, a clock 26, a device controller 30, a media drive 32, a USB module 34, a flash memory 36, a wireless communication module 38, a wire communication module 40, a subsystem 50, and a main system 60.

The main system 60 includes a main central processing unit (CPU), a memory as a main storage device and a memory controller, and a graphics processing unit (GPU). The GPU is used mainly for arithmetic processing of a game program. These functions may be constructed as a system on chip, and thus formed on one chip. The main CPU has a function of executing game software recorded in the auxiliary storage device 2 or on a ROM medium 44.

The sub-system 50 includes a sub-CPU, a memory as a main storage device and a memory controller. The sub-system 50 does not include a GPU, and does not have a function of executing a game program. The number of circuit gates of the sub-CPU is smaller than the number of circuit gates of the main CPU. The power consumption in operation of the sub-CPU is lower than the power consumption in operation of the main CPU. The sub-CPU operates while the main CPU is in a standby state, and the processing functions of the sub-CPU are limited to keep the power consumption low.

The main power supply button 20 is a button where operating input from the user is performed. The main power supply button 20 is provided to a front surface of a casing of the information processing device 10. The main power supply button 20 is operated to turn on or off the supply of power to the main system 60 of the information processing device 10. The power-on LED 21 is lit when the main power supply button 20 is turned on. The standby LED 22 is lit when the main power supply button 20 is turned off.

The system controller 24 detects the depression of the main power supply button 20 by the user. When the main power supply button 20 is depressed while the main power supply is in an off state, the system controller 24 obtains the depressing operation as a “turn-on instruction.” When the main power supply button 20 is depressed while the main power supply is in an on state, on the other hand, the system controller 24 obtains the depressing operation as a “turn-off instruction.”

The clock 26 is a real-time clock. The clock 26 generates present date and time information, and supplies the present date and time information to the system controller 24, the subsystem 50, and the main system 60.

The device controller 30 is configured as a large-scale integrated circuit (LSI) that transfers information between devices like a Southbridge. As depicted in FIG. 2, the device controller 30 is connected with devices such as the system controller 24, the media drive 32, the USB module 34, the flash memory 36, the wireless communication module 38, the wire communication module 40, the subsystem 50, and the main system 60. The device controller 30 accommodates differences between electrical characteristics of the respective devices and differences between data transfer rates, and controls data transfer timing.

The media drive 32 is a drive device that is loaded with the ROM medium 44 on which application software such as a game is recorded, drives the ROM medium 44, and reads a program and data from the ROM medium 44. In the following, programs and data may be referred to collectively as data when the programs and the data are not particularly distinguished from each other. However, “data” will be used also to represent elements constituting files. The ROM medium 44 is a read-only recording medium such as an optical disk, a magneto-optical disk, and a Blu-ray disk.

The USB module 34 is a module connected to an external device by a USB cable. The USB module 34 may be connected to the auxiliary storage device 2 and the camera 7 by a USB cable. The flash memory 36 is an auxiliary storage device forming an internal storage. The wireless communication module 38 performs wireless communication with, for example, the input device 6 under a communication protocol such as a Bluetooth (registered trademark) protocol and an institute of electrical and electronic engineers (IEEE) 802.11 protocol. Incidentally, the wireless communication module 38 may support a third-generation (3rd Generation) digital mobile telephone system compliant with an international mobile telecommunication 2000 (IMT-2000) standard defined by the international telecommunication union (ITU), or may further support a digital mobile telephone system of another generation. The wire communication module 40 performs wire communication with an external device. The wire communication module 40 is connected to the network 3 via the AP 8.

Returning to FIG. 1, the content server 12 provides game software and patch data for the game software to the information processing device 10. The game software includes a startup file, a resource file group for executing a game such as a game program, and a file group used by the OS of the information processing device 10. The content server 12 provides the image file of the game software originally recorded on the ROM medium 44 to the information processing device 10. The game program is necessary to execute the game. The game progresses by running the game program. The startup file is a program for starting the game program. When the startup file is executed, the game program is called up and executed. The file group used by the OS includes a game icon image to be displayed on a menu screen in the information processing device 10.

The game software has a tree type directory structure. A root directory in a top layer includes the startup file. Subdirectories in a lower layer are classified by file type. For example, a subdirectory for 3-dimentional (3D) models, a subdirectory for textures, and a subdirectory for scripts are formed as the subdirectories in the lower layer. Each subdirectory includes corresponding files. The subdirectory for 3D models includes a plurality of 3D model files. The subdirectory for textures includes a plurality of texture files. The subdirectory for scripts includes a plurality of script files. For example, the subdirectory for textures includes a texture file for scene 1, a texture file for scene 2, and a texture file for scene 3 of the game.

The patch data is applied to the game software at a time of execution of the game software. The patch data includes a game program in which a bug is corrected and a data file for changing a game function. The patch data may have a same file configuration as the game software, and may for example include files to be replaced with files included in the game software.

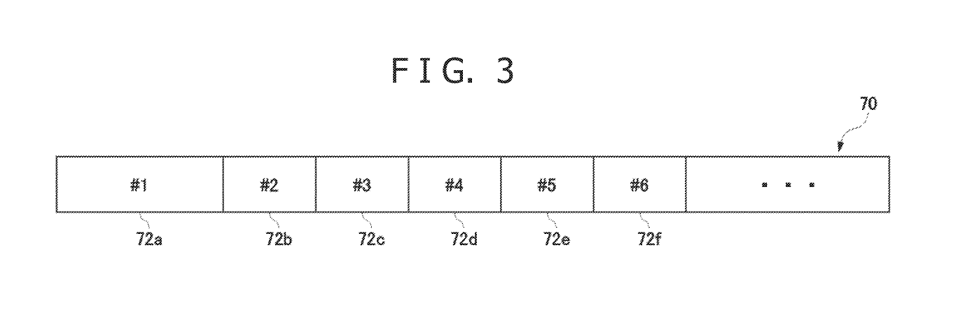

FIG. 3 depicts a conceptual diagram of a file configuration of the game software. Game software 70 according to the embodiment is formed by a plurality of files, and is logically divided into a plurality of groups 72, as depicted in the figure. Each file belongs to at least one of the plurality of groups 72, and at least one file belongs to each group 72. The game software 70 depicted in FIG. 3 includes a first group 72a as a front group, and a second group 72b, a third group 72c, a fourth group 72d, a fifth group 72e, and a sixth group 72f as groups following the first group 72a. Incidentally, there may be a seventh and subsequent groups 72 following the sixth group 72f. Each group is identified by a group number such as the first, the second, or the like.

The files included in the plurality of subdirectories belong to the respective groups that are divided logically. That is, each group is formed by files of different types, and is set such that files necessary for the information processing device 10 to execute a particular unit such as a scene and a stage in the game belong to each group.

A program file and a data file necessary to start the game software 70 belong to the first group 72a. Hence, when the information processing device 10 obtains the game software 70 from the content server 12, if the information processing device 10 has downloaded all of the files belonging to the first group 72a, the information processing device 10 can immediately start the game software 70 even if the information processing device 10 has not downloaded the files of the following second group 72b and the subsequent groups. Incidentally, after the information processing device 10 has obtained all of the files belonging to the first group 72a and started the game software 70, the information processing device 10 downloads the files belonging to the following groups 72 in the background. The download waiting time of the user can be shortened by thus making a minimum of files necessary to execute the game downloaded first and allowing the game to be executed at a point in time that these files are obtained. Incidentally, in the embodiment, the game software 70 recorded on the ROM medium 44 and the game software 70 downloaded from the content server 12 or the like have a data structure with a same file and directory configuration.

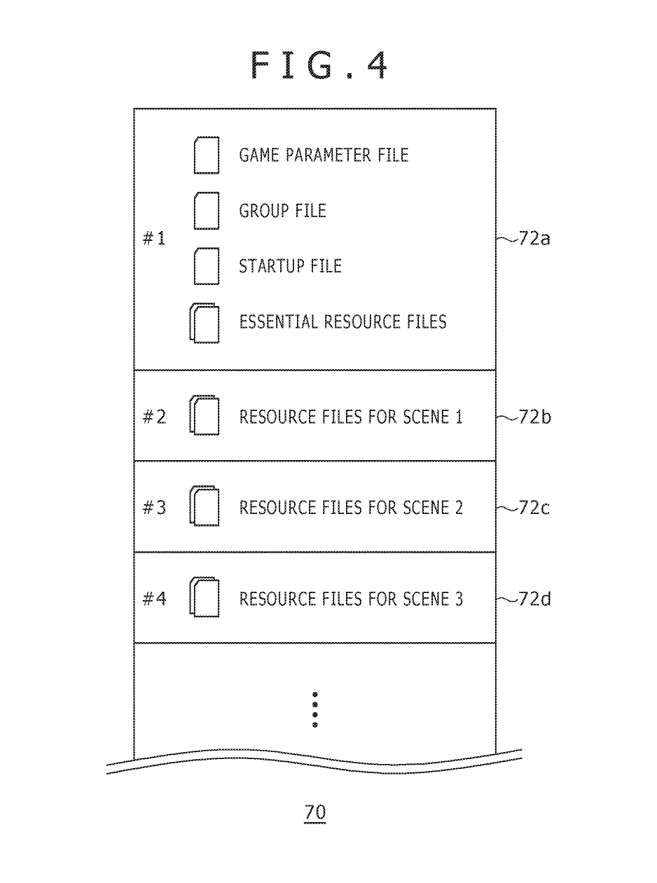

FIG. 4 depicts a concrete example of file configuration of the game software. The first group 72a is formed by a file group to be downloaded first in the game software 70. In this case, a game parameter file, a group file, a startup file, and an essential resource file are depicted as the first group 72a.

Here, the game parameter file is used by the OS of the information processing device 10. The game parameter file includes information such as a title identification (ID) and a display resolution and icon image data.

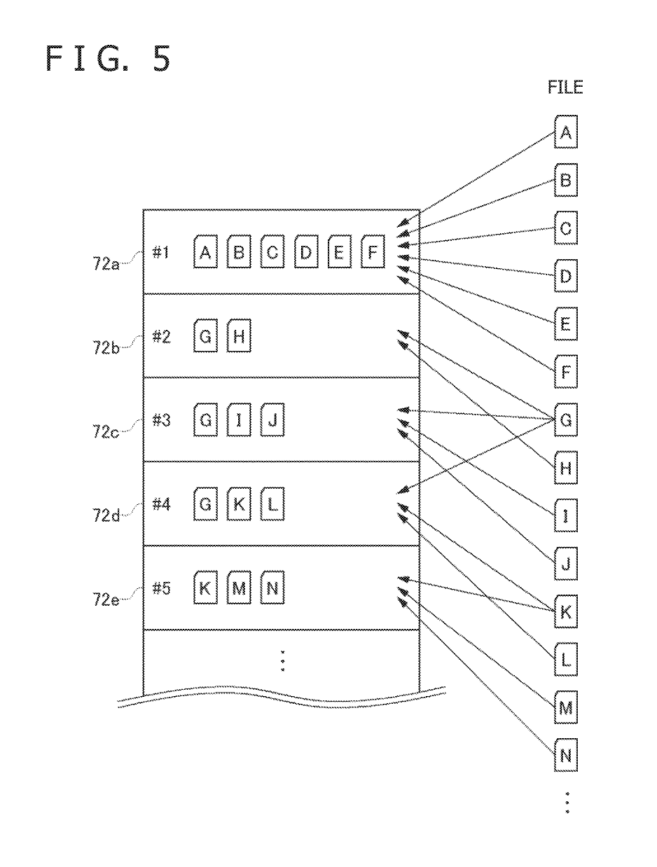

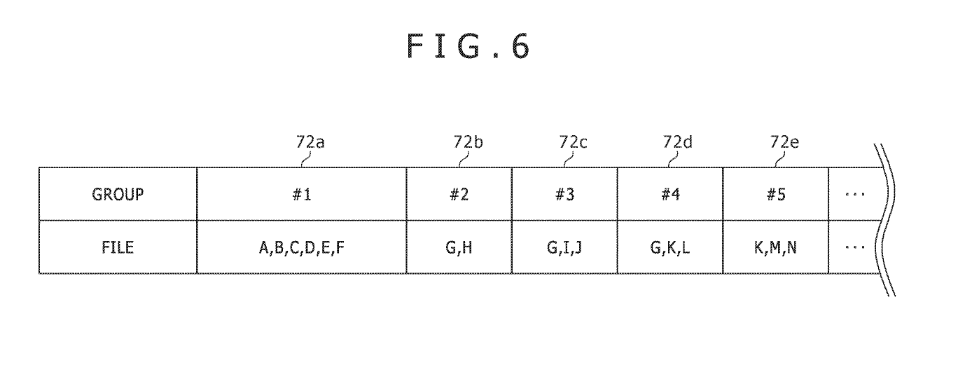

The group file is a definition file describing in which group each file is included. For example, the group file may be represented in extensible markup language (XML). However, the group file may be represented in another program language in any form. The group file will be described later with reference to FIG. 5 and FIG. 6.

The startup file is a program for starting the game program. The essential resource file includes a resource file such as a program essential for the execution of the game or the like and a common file used in the whole of the game.

When the information processing device 10 downloads the game software 70 from the content server 12 or the like, the information processing device 10 can start the game when obtaining and installing the entire file group belonging to the first group 72a. Conversely, the first group 72a includes a file group necessary for the user to play part of the game. Incidentally, the game play in this case may also include a setting action performed at a time of a start of the game, such for example as determination of a character or determination of a game level by the user. That is, the first group 72a includes a file group necessary to start the game and allow the user to perform at least some operation. The game play that can be performed using the file group included in the first group 72a may be for example only an initial setting for the game or such that up to a first stage of the game can be played. This depends on the game manufacturer.

In the example depicted in FIG. 4, a plurality of resource files for scene 1 belong to the second group 72b, a plurality of resource files for scene 2 belong to the third group 72c, and a plurality of resource files for scene 3 belong to the fourth group 72d. Specifically, the plurality of resource files include programs, 3D model files, texture files and script files for the particular scenes, and further include files included in the plurality of subdirectories of the directory structure.

FIG. 5 depicts an example of relation between groups and files. In this case, files A to N are depicted belonging to respective groups 72. As depicted in the figure, each file belongs to at least one of a plurality of groups 72, and at least one file belongs to each group 72. Incidentally, the file G belongs to the second group 72b, the third group 72c, and the fourth group 72d. This means that the file G is necessary to form scene 1, scene 2, and scene 3 in the game. One file may thus belong to a plurality of groups. Incidentally, the file K also belongs to a plurality of groups 72, that is, the fourth group 72d and the fifth group 72e.

FIG. 6 depicts an example of a group file. As described above, the group file may be represented in XML, or may be represented in another program language. FIG. 6 depicts a group file representing correspondence relation between groups and files in a table format to facilitate understanding. When the information processing device 10 downloads each file of the game software 70, the information processing device 10 can determine whether all files belonging to a certain group are obtained or not obtained by referring to the group file. For example, as for the first group 72a, the information processing device 10 can recognize that the files belonging to the first group 72a are files A, B, C, D, E, and F by referring to the group file. Thus, when these files are recorded in the auxiliary storage device 2, the information processing device 10 determines that all of the files belonging to the first group 72a are obtained. Incidentally, the group file may be one of the files A to F.

The game software 70 is thus formed by a plurality of groups, whereby the information processing device 10 can download files according to download order defining the order of priority of downloading the groups. When the game software 70 includes resource files for single play in which one person plays and resource files for multiple play in which a plurality of people play, and the user desires single play, after the first group 72a is firstly downloaded, a group for single play is preferentially downloaded, and a group for multiple play is downloaded in the background while the single play is enjoyed. When the user desires multiple play, on the other hand, after the first group 72a is firstly downloaded, the group for multiple play is preferentially downloaded, and the group for single play is downloaded in the background while the multiple play is enjoyed.

The first group 72a is set by default as a group to be downloaded first in download order. Subsequent download groups may be specified by the game. As described above, when the user selects single play, the game specifies the download order of the group for single play according to order of game progress. Efficient downloading of the game software 70 is thereby realized.

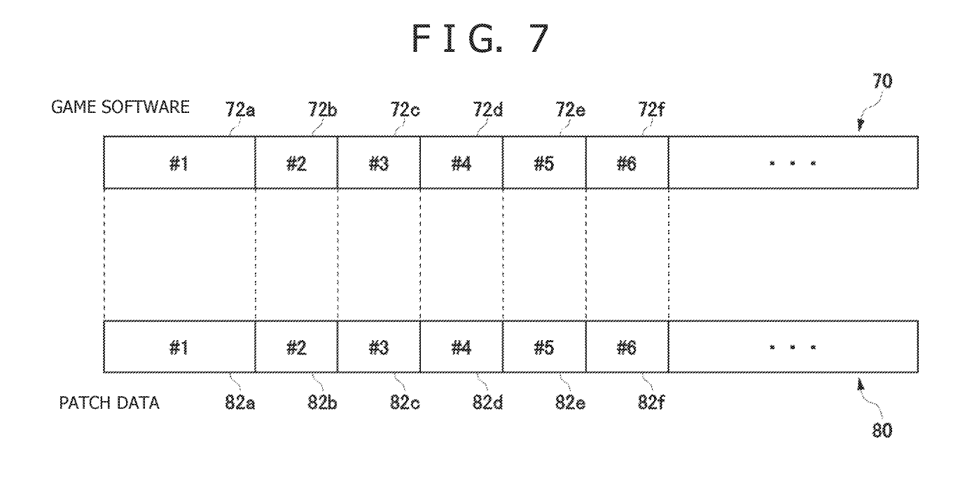

FIG. 7 depicts relation between the game software and the patch data. Patch data 80 in the embodiment is formed by a plurality of files, and is logically divided into a plurality of groups 82 as in the game software 70. Each file of the patch data 80 belongs to at least one of the plurality of groups 82, and at least one file belongs to each group 82. The patch data 80 depicted in FIG. 7 includes a first group 82a as a head group, and includes a second group 82b, a third group 82c, a fourth group 82d, a fifth group 82e, and a sixth group 82f as groups following the first group 82a. Incidentally, there may be a seventh and subsequent groups 82 following the sixth group 82f.

One group 82 of the patch data 80 is associated with one group 72 of the game software 70. Incidentally, no group 82 of the patch data 80 may be associated with a group 72 of the game software 70 to which group no patch needs to be applied. The information processing device 10 can execute the game in a latest state by applying the latest patch data 80 to the game software 70. The groups 82 of the patch data 80 correspond to the respective groups 72 of the game software 70. Therefore, when the information processing device 10 downloads files belonging to a certain group 72 of the game software 70, the information processing device 10 next downloads files belonging to a corresponding group 82 (having the same group number in the present example) of the patch data 80. This enables the corresponding group 82 of the patch data 80 to be immediately applied to the group 72 of the game software 70.

Incidentally, this state assumes that the patch data 80 is already prepared in the content server 12 when the user downloads the game software 70. In the embodiment, in the case where the content server 12 retains the patch data 80 for the game software 70, the information processing device 10 downloads, as a set, files belonging to a group 72 of the game software 70 and files belonging to a group 82 of the patch data 80 which group 82 corresponds to the group 72. That is, after the information processing device 10 downloads an Lth group of the game software 70, the information processing device 10 downloads a corresponding Lth group of the patch data 80 so that the game software and patches are downloaded as a set in each group.

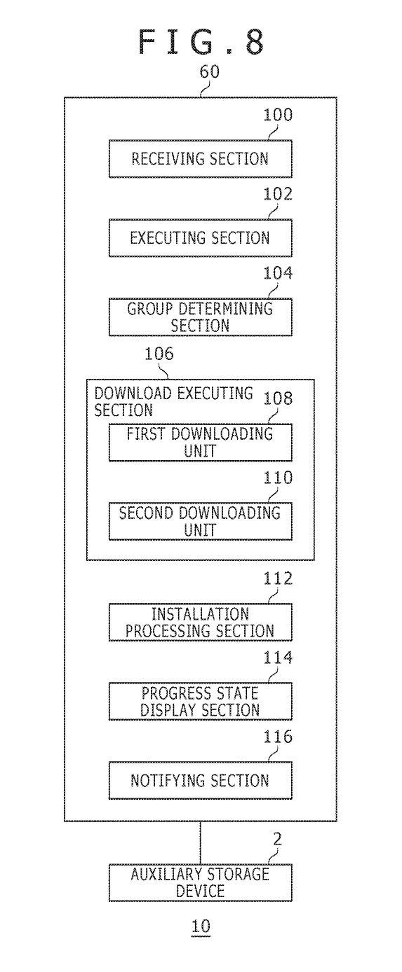

FIG. 8 depicts functional blocks for performing download processing in the information processing device 10. In this case, the download processing is processing of obtaining (downloading) the game software 70 and the patch data 80 from the content server 12 in group units.

The main system 60 includes a receiving section 100, an executing section 102, a group determining section 104, a download executing section 106, an installation processing section 112, a progress state display section 114, and a notifying section 116. These configurations are implemented, in terms of hardware components, by the CPU of an arbitrary computer, a memory, a program loaded in the memory, and a storage. In this case, however, the functional blocks implemented by cooperation of these components are depicted. Hence, it is to be understood by those skilled in the art that these functional blocks can be implemented in various forms by only hardware, only software, or combinations of hardware and software.

The receiving section 100 receives operation information about an operation of the input device 6 by the user. The download executing section 106 includes a first downloading unit 108 that downloads the game software 70 from the content server 12 and a second downloading unit 110 that downloads the patch data 80 from the content server 12. The download executing section 106 totals amounts of downloaded data. Incidentally, in the embodiment, the first downloading unit 108 and the second downloading unit 110 are distinguished from each other for convenience in order to indicate different download objects, but may be practically formed by a single downloading module.

In the processing of downloading the game software 70 and the patch data 80, the auxiliary storage device 2 is used as a storage device for storing a plurality of files constituting the game software 70 and the patch data 80. In the game software 70 and the patch data 80, each file belongs to at least one group, and at least one file belongs to each group. The download processing is performed in group units. For example, when files X, Y, and Z belong to a group S, and a request to download the group S is generated, the files X, Y, and Z are downloaded from the content server 12, and all of the files X, Y, and Z belonging to the group S are recorded in the auxiliary storage device 2. Incidentally, when the file X has already been downloaded, the files Y and Z are downloaded from the content server 12, and thereby all of the files X, Y, and Z belonging to the group S are recorded in the auxiliary storage device 2.

The progress state display section 114 has a function of displaying a download progress state on the output device 4. In the embodiment, the download executing section 106 downloads the game software 70 and the patch data 80 as sets in group units. Accordingly, the progress state display section 114 has a function of displaying a state of progress of downloading a combined total of the game software 70 and the patch data 80 in a form of one progress bar, for example, on the output device 4.

The installation processing section 112 installs the downloaded game software 70 and the downloaded patch data 80. The executing section 102 executes the game by using the installed game software 70 and the installed patch data 80. As already described, when the first group of the game software 70 and the patch data 80 is installed, the executing section 102 can execute the game immediately. Incidentally, while the game is illustrated as an example of an application in the embodiment, the executing section 102 also has a function of executing another application by using application software and patch data.

A concrete downloading procedure in the information processing device 10 will be described.

At a time of purchase of game software by the user, the receiving section 100 receives the address of a page for selling game software, and displays the selling page on the output device 4. When the user selects desired game software by operating the input device 6, license information is given to the information processing device 10 after charging processing is performed, and a download request including game identifying information (title ID) identifying the selected game software is transmitted to the content server 12. Thus, the content server 12 becomes able to distribute the game software 70 and the patch data 80 specified by the game identifying information to the information processing device 10.

In the embodiment, the content server 12 retains the game software 70 and the patch data 80. For example, there is a case where the patch data 80 is already prepared at a time of starting to sell the game software 70. However, there is also a case where the patch data 80 is generated for a purpose of supplementing a scenario or the like after the passage of a time from the start of the sale. In either case, in the embodiment, it is desirable for the information processing device 10 to download the game software 70 and the patch data 80 at the same time so that the user can play the game immediately with a latest patch applied.

The receiving section 100 receives information indicating a total amount of data of the first group 72a of the game software 70 and the first group 82a of the patch data 80 and a total amount of data of the game software 70 and the patch data 80, together with response information that permits a download from the content server 12. Here, when the first group 72a has a data size of 1 Gbyte, and the first group 82a has a data size of 0.5 Gbytes, a total amount of data of the first group is 1.5 Gbytes. In addition, when the game software 70 has a data size of 10 Gbytes, and the patch data 80 has a data size of 5 Gbytes, a total amount of data of the game software 70 and the patch data 80 is 15 Gbytes.

After the receiving section 100 receives the total amount of data of the first group of the game software 70 and the patch data 80 and the total amount of data of the whole of the game software 70 and the patch data 80 together with the response information, the group determining section 104 determines a group of the game software 70 which group is to be downloaded by the download executing section 106. At a time of a start of the download processing, the group determining section 104 determines the first group 72a of the game software 70 as an object to be downloaded first. The download executing section 106 transmits, to the content server 12, a download request including information identifying the group determined by the group determining section 104 (group identifying information).

After receiving the download request including the group identifying information, the content server 12 transmits files belonging to the group 72 of the game software 70 which group is specified by the group identifying information to the information processing device 10. When there is a group 82 of the patch data 80 which group corresponds to the group 72, the content server 12 also transmits files belonging to the group 82 to the information processing device 10. In the information processing device 10, the first downloading unit 108 downloads the transmitted files of the game software 70, and the second downloading unit 110 downloads the next transmitted files of the patch data 80.

After the content server 12 transmits the files included in the first group 72a of the game software 70, the first downloading unit 108 downloads the transmitted files, and records the files in the auxiliary storage device 2. After the content server 12 next transmits the files included in the first group 82a of the patch data 80, the second downloading unit 110 downloads the transmitted files, and records the files in the auxiliary storage device 2. The group determining section 104 determines a group of the game software 70 which group is to be downloaded next. The download executing section 106 transmits a download request including information identifying the determined group to the content server 12.

When the files of the first group have been installed, and the game has been started, the group determining section 104 determines a group to be downloaded next according to a request from the game. Incidentally, when the game has not been started, the group determining section 104 sets the order of groups to be downloaded in the same manner as the numerical order of the groups. That is, the group determining section 104 may determine a group having a smaller number as an object to be downloaded earlier in the order. After the group determining section 104 determines the order of the groups to be downloaded, the group determining section 104 notifies the order to the download executing section 106. The download executing section 106 downloads files included in the group according to the order.

The following description will be made of a download progress state presented when a game having a title “ABC tennis” is downloaded.

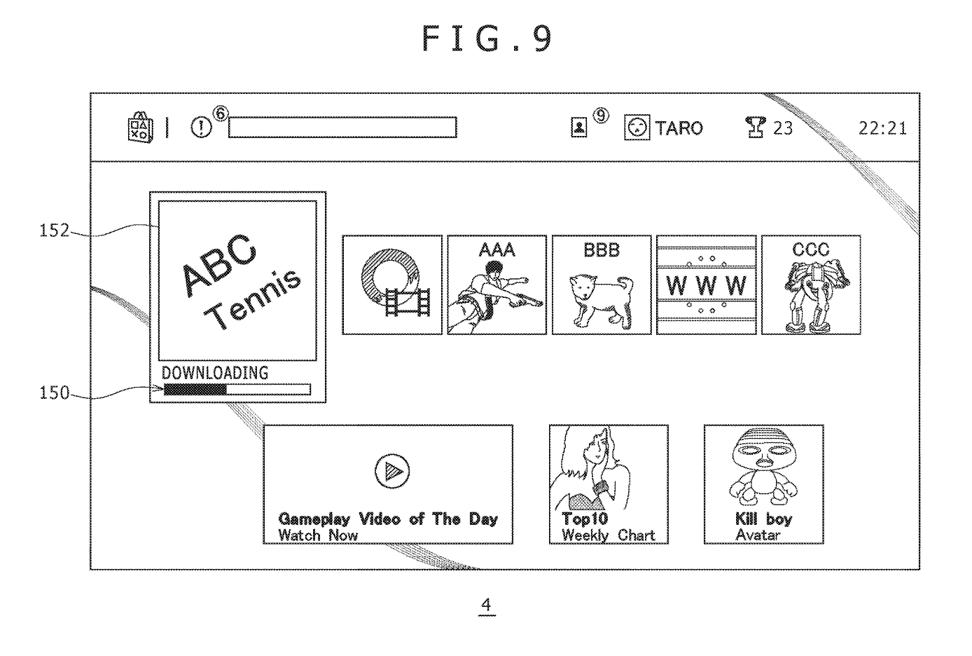

FIG. 9 depicts an example of a home screen. Icons of installed games and applications are arranged on the home screen. During the downloading of a first group, a progress bar 150 is displayed below an icon 152 of “ABC tennis.”

The progress state display section 114 displays the progress bar 150 below the icon 152 to depict a state of progress of downloading a combined total of files of the game software 70 which files belong to the first group 72a and files of the patch data 80 which files belong to the first group 82a. For example, when the first group 72a has a data size of 1 Gbytes, and the first group 82a has a data size of 0.5 Gbytes, the progress bar 150 represents a ratio of an amount of already downloaded data to 1.5 Gbytes, which is a total amount of data of the first group. The executing section 102 can start “ABC tennis” after the files of the first group 72a of the game software 70 and the first group 82a of the patch data 80 are installed. Therefore, rather than representing the progress state of all of the files constituting the game software 70 and the patch data 80, the progress state display section 114 presents the download progress state of the files belonging to the first group 72a and the first group 82a that enable a start of the game, so that the user can recognize a waiting time taken before a start of the game.

The progress state display section 114 displays the download progress state on the home screen. However, the progress state display section 114 may display the download progress state on another system screen.

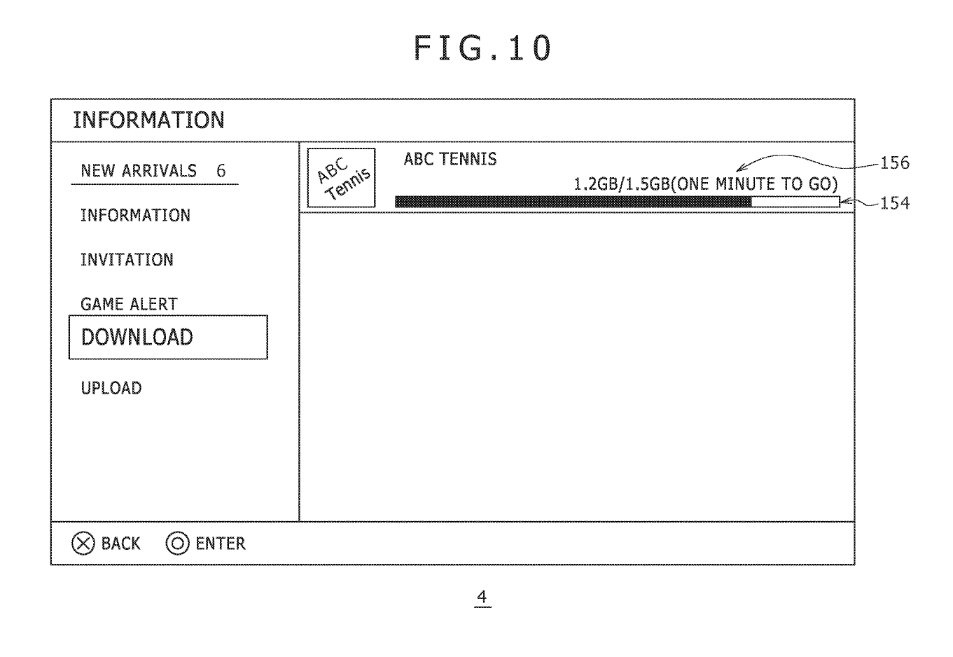

FIG. 10 depicts an example of a download confirmation screen. Also on the download confirmation screen, the progress state display section 114 displays the state of progress of downloading a combined total of files of the game software 70 which files belong to the first group 72a and files of the patch data 80 which files belong to the first group 82a. In this case, the progress state display section 114 displays a progress bar 154 and data size information 156 as the download progress state. When the first group 72a has a data size of 1 Gbytes, and the first group 82a has a data size of 0.5 Gbytes, the progress bar 154 represents, as a horizontal bar, a ratio of an amount of already downloaded data (1.2 Gbytes) to 1.5 Gbytes, which is the total amount of data, and the data size information 156 represents, by numbers, the ratio of the amount of already downloaded data (1.2 Gbytes) to 1.5 Gbytes, which is the total amount of data.

When the download executing section 106 completes downloading the files of the game software 70 which files belong to the first group 72a and the files of the patch data 80 which files belong to the first group 82a, the progress state display section 114 displays information indicating the completion of the download on the download confirmation screen. The installation processing section 112 next installs the downloaded files.

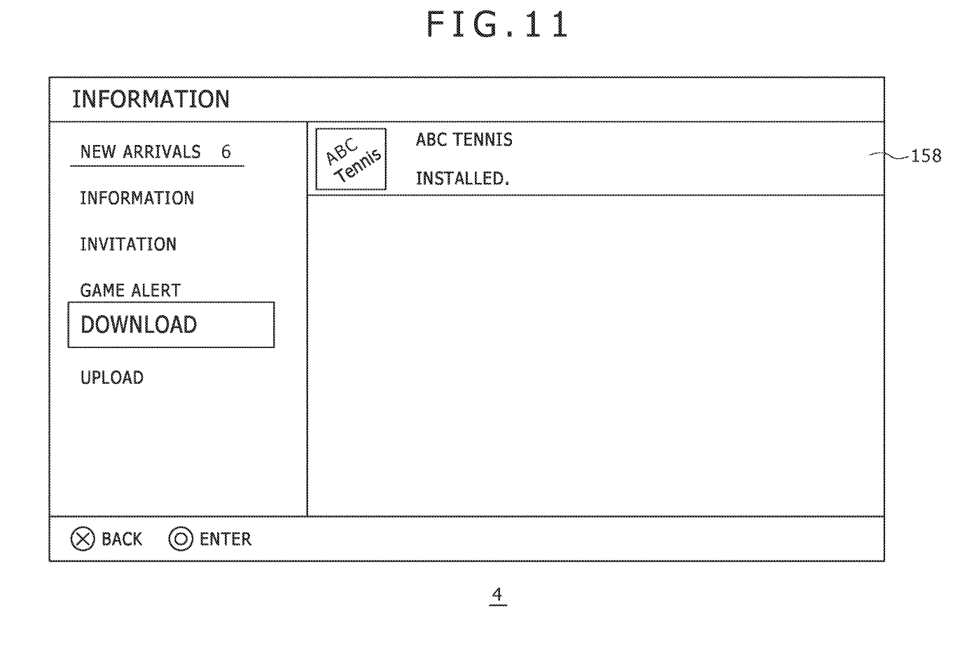

FIG. 11 depicts an example of the download confirmation screen. When the installation processing section 112 completes the processing of installing the downloaded files, the progress state display section 114 makes display indicating the completion of the processing of installing the downloaded first group on the download confirmation screen.

Thus, when the download of the files of the game software 70 which files belong to the first group 72a and the files of the patch data 80 which files belong to the first group 82a is completed, or the installation of the files of the game software 70 which files belong to the first group 72a and the files of the patch data 80 which files belong to the first group 82a is completed, the progress state display section 114 displays information indicating the completion on the download confirmation screen. A display region 158 that displays the information indicating the completion constitutes a GUI selectable by the user. When the user performs an operation of selecting the display region 158, the receiving section 100 receives the selecting operation as an instruction to start the game (ABC tennis).

Incidentally, when the installation of the files of the game software 70 which files belong to the first group 72a and the files of the patch data 80 which files belong to the first group 82a is completed, the notifying section 116 makes pop-up display of information indicating that the installation is completed on the output device 4. The notifying section 116 may make pop-up display indicating that the installation is completed and that “ABC tennis” can be played on the download confirmation screen. However, it is particularly desirable that the notifying section 116 makes the pop-up display on a screen other than the download confirmation screen. For example, in a case where the home screen is displayed on the output device 4, or in a case where the user is playing another game and a game screen is displayed on the output device 4, the pop-up display indicating the completion of the installation of “ABC tennis” by the notifying section 116 can inform the user that “ABC tennis” can be played.

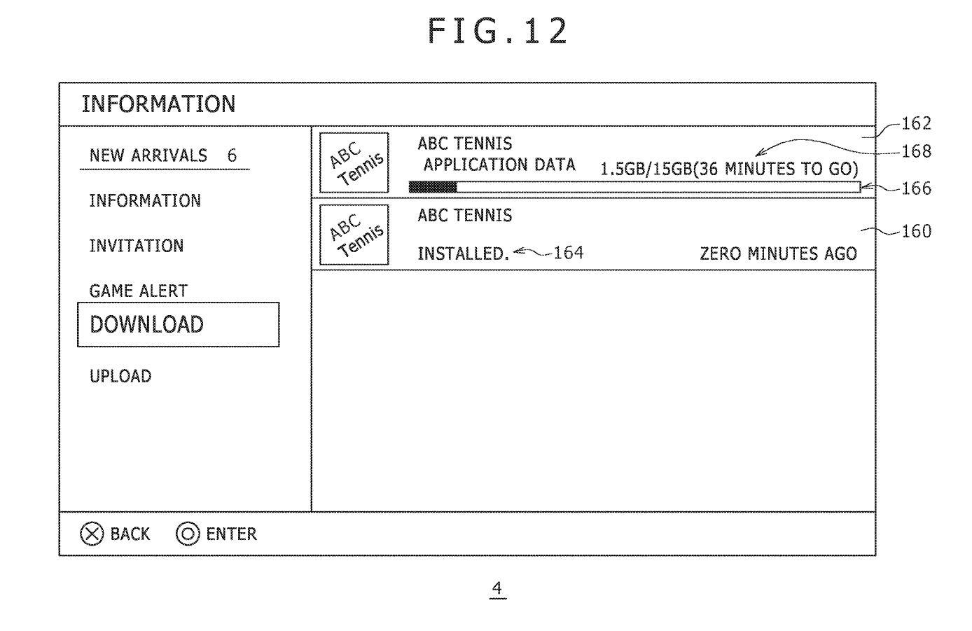

FIG. 12 depicts an example of the download confirmation screen. When the installation of the first group is completed, the download executing section 106 starts to download the second and subsequent groups of the game software 70 and the patch data 80 according to group information determined by the group determining section 104. The progress state display section 114 displays installation completion information 164 indicating the completion of the installation in a first display region 160, and displays a state of progress of downloading a combined total of files of the game software 70 and files of the patch data 80 which files belong to the second and subsequent groups in a second display region 162. In this case, the progress state display section 114 displays a progress bar 166 and data size information 168 as the download progress state. When the game software 70 has a data size of 10 Gbytes, and the patch data 80 has a data size of 5 Gbytes, the progress bar 166 represents, as a horizontal bar, a ratio of an amount of already downloaded data (1.5 Gbytes) to 15 Gbytes, which is the total amount of data, and the data size information 168 represents, by numbers, the ratio of the amount of already downloaded data (1.5 Gbytes) to 15 Gbytes, which is the total amount of data.

In the embodiment, the download state of one game is expressed in two divided display regions, that is, the first display region 160 and the second display region 162. When consideration is given to a case of making the expression in one display region, for example, it is difficult for the user to determine that the game can be started even when viewing the display contents because the download continues to be performed. Accordingly, the user is enabled to recognize the download state easily by expressing the download state in the two display regions as in the embodiment, using the first display region 160 displaying the installation completion information 164 as a GUI for giving an instruction to start the game, and using the second display region 162 to express the download state of the whole.

When the download executing section 106 starts to download the second and subsequent groups of the game software 70 and the patch data 80, the download of the first group is already completed, that is, the download of 1.5 Gbytes of the first group 72a and the first group 82a is completed. The progress state display section 114 therefore displays the download progress state in the second display region 162 so as to depict that the download of 1.5 Gbytes of 15 Gbytes as the total amount of data is completed. When the progress state is displayed in the second display region 162 so as to enable a comparison of the amount of already downloaded data with the total amount of data of the game software 70 and the patch data 80, the user can intuitively grasp the download progress state.

As described above, the first display region 160 is configured to give an instruction to start the game when the user performs an operation of selecting the first display region 160. Information indicating the number of minutes that have elapsed since a time of completion of file installation of the first group is displayed in the first display region 160.

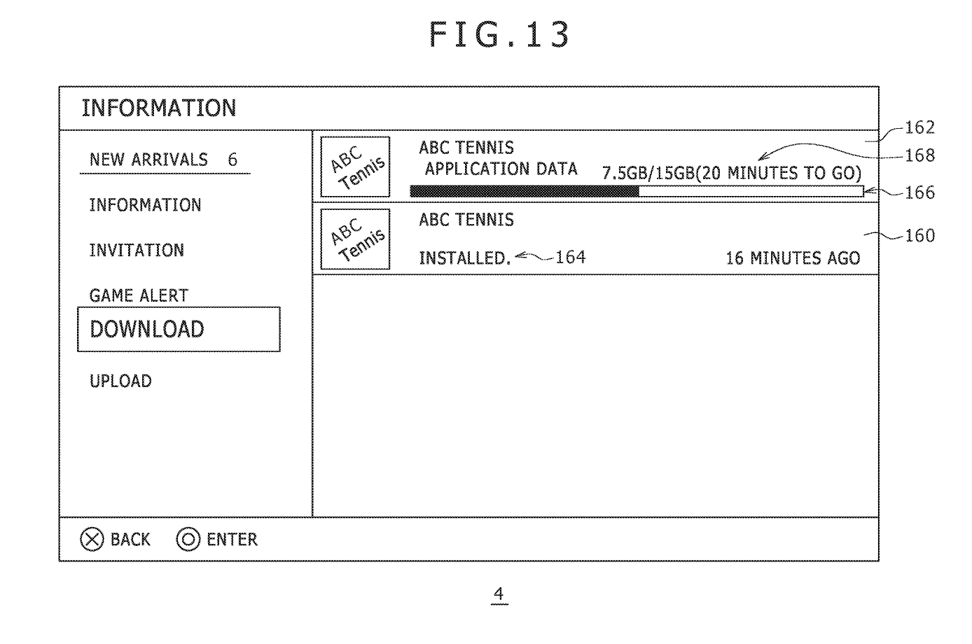

FIG. 13 depicts an example of the download confirmation screen. The download confirmation screen depicts a state in which the download executing section 106 is downloading the second and subsequent groups of the game software 70 and the patch data 80, and has downloaded 7.5 Gbytes. As already described, the first downloading unit 108 and the second downloading unit 110 respectively download files belonging to the game software 70 and the patch data 80 in the same group. The progress state display section 114 displays the progress bar 166 and the data size information 168 as the download progress state using the total amount of data of the game software 70 and the patch data 80 and the cumulative amount of already downloaded data. The progress bar 166 represents, as a horizontal bar, a ratio of the amount of already downloaded data (7.5 Gbytes) to 15 Gbytes, which is the total amount of data. The data size information 168 represents, by numbers, the ratio of the amount of already downloaded data (7.5 Gbytes) to 15 Gbytes, which is the total amount of data.

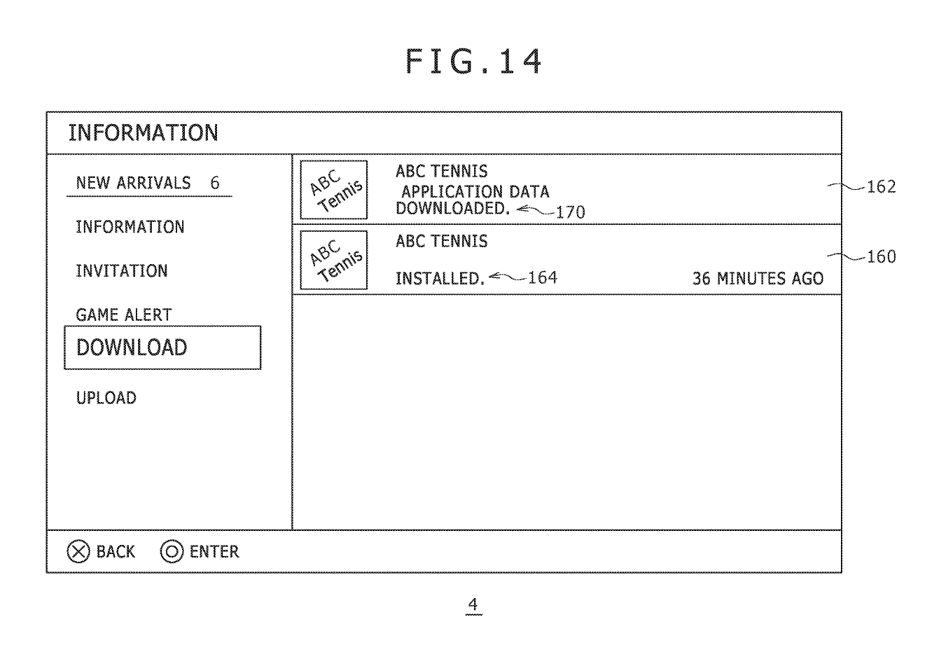

FIG. 14 depicts an example of the download confirmation screen. When the download executing section 106 completes downloading all of files of the game software 70 and the patch data 80, the progress state display section 114 displays download completion information 170 indicating the completion of the download in the second display region 162. Incidentally, the installation completion information 164 indicating the completion of the installation of the first group continues being displayed in the first display region 160.

It is to be noted that even when the download of all of the files of the game software 70 and the patch data 80 is completed, or the installation of all of the files of the game software 70 and the patch data 80 is completed, the notifying section 116 does not make pop-up display of information indicating the completion on the output device 4. Pop-up display is forcibly superimposed on the screen. Thus, making the pop-up display of the information with a high frequency disturbs the user, and is therefore undesirable. In the case of the download processing in the embodiment, the completion of the download of all the files of the game software 70 and the patch data 80 indicates that all of the game can be executed. However, the execution of the game is already possible at a point in time that the installation of all the files of the first group is completed. It is therefore considered that information indicating the completion of the download of all the files of the game software 70 and the patch data 80 is not very important information for the user. Hence, the pop-up display of this information is not made. Incidentally, the user can check that the download of all the files is completed from the download confirmation screen depicted in FIG. 14.

Incidentally, the first display region 160 displaying the installation completion information 164 and the second display region 162 displaying the download completion information 170 are configured to give an instruction to start the game when selected by the user. When an operation of selecting one of the first display region 160 and the second display region 162 is performed, the receiving section 100 receives the selecting operation as an instruction to start the “ABC tennis” game, and the executing section 102 starts the “ABC tennis” game.

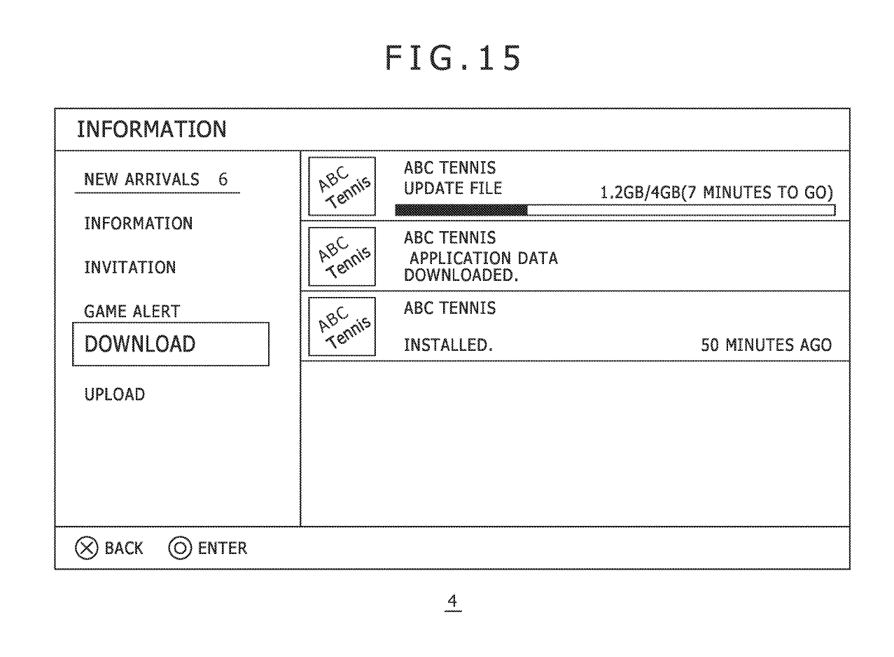

FIG. 15 depicts an example of the download confirmation screen. The present example assumes a case where latest patch data is uploaded to the content server 12 after the completion of the download of the game software 70 and the patch data 80. When the latest patch data becomes downloadable from the content server 12, the download executing section 106 downloads the latest patch data as update files, and the progress state display section 114 displays a state of progress of downloading the update files on the download confirmation screen. The update files are also formed by a plurality of groups. The download executing section 106 downloads the update files en bloc in the numerical order of the groups, for example.

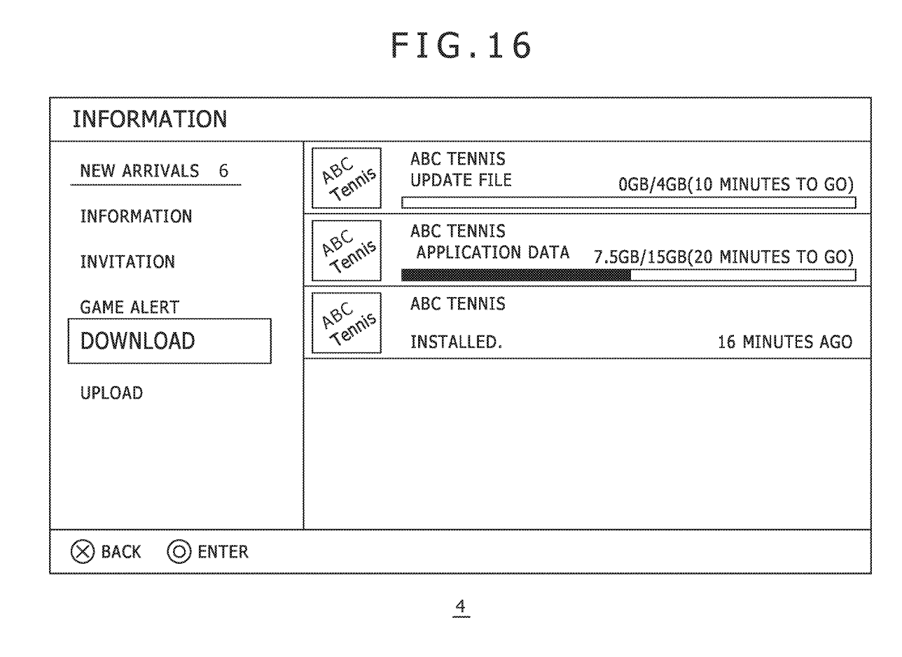

FIG. 16 depicts an example of the download confirmation screen. The present example assumes a case where latest patch data is uploaded to the content server 12 while the second and subsequent groups are being downloaded after the installation of the first group of the game software 70 and the patch data 80. When the latest patch data becomes newly downloadable from the content server 12, the download executing section 106 continues the download processing in group units, and downloads the update files en bloc.

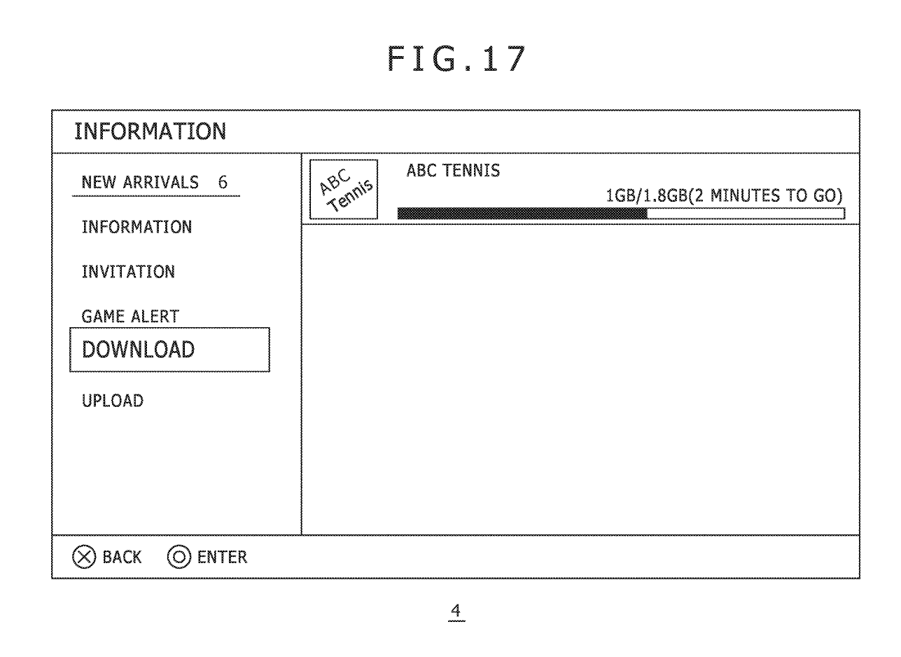

FIG. 17 depicts an example of the download confirmation screen. The present example assumes a case where latest patch data is uploaded to the content server 12 before completion of the download of the first group of the game software 70 and the patch data 80. Suppose for example that, as depicted in FIG. 10, the latest patch data becomes downloadable from the content server 12 when 1.2 Gbytes of the first group has already been downloaded. That is, the present example is a case where the latest patch data becomes downloadable in a state in which the installation of the first group is not completed.

Here, the already downloaded 1.2 Gbytes includes 1 Gbyte of the first group 72a of the game software 70 and 0.2 Gbytes of the first group 82a of the patch data 80. That is, the download of all the files of the first group 72a is completed, while the first group 82a has only been downloaded halfway. When the latest patch data becomes downloadable in this state, the download executing section 106 deletes the 0.2 Gbytes of the first group 82a from the auxiliary storage device 2, and downloads anew files belonging to the first group of the latest patch data. At this time, the receiving section 100 receives the data size (0.8 Gbytes) of the first group of the latest patch data, and the progress state display section 114 displays a download progress state so as to enable a comparison of an amount of already downloaded data of the first group with a total amount of data (1.8 Gbytes) of the first group. FIG. 17 depicts the progress state when the first group of the new patch data is downloaded anew.

The above description has been made of examples of display of a progress state when the game software 70 and the patch data 80 are simultaneously downloaded from the network 3. The embodiment is illustrative, and it is to be understood by those skilled in the art that combinations of constituent elements and processing processes of the embodiment are susceptible of various modifications, and that such modifications also fall within the scope of the present technology. In the embodiment, a game is illustrated as an example of an application, but may be another application.

In the information processing system 1, routes for the information processing device 10 to obtain the game software 70 include not only a route of downloading the game software 70 from the content server 12 but also a route of reading the game software 70 recorded on the ROM medium 44. In this case, when the patch data 80 is also recorded on the ROM medium 44, the information processing device 10 can apply the patch to the game software on the ROM medium 44 without downloading the update files of the patch data 80 from the content server 12. The present modification assumes that the game software 70 and the patch data 80 retained by the content server 12 in the embodiment are recorded on the ROM medium 44.

The game software recorded on the ROM medium 44 is read from the media drive 32 to a main memory at a relatively low speed as compared with a speed of data readout from the auxiliary storage device 2 to the main memory. Accordingly, in the information processing device 10 according to the modification, when the ROM medium 44 is first inserted into the media drive 32, a copy processing section (not depicted) may copy the files belonging to the first group 72a of the game software 70 and the files belonging to the first group 82a of the patch data 80 from the ROM medium 44 to the auxiliary storage device 2, and the installation processing section 112 may install the files, so that the game can be started. At this time, the progress state display section 114 displays, on the output device 4, a state of progress of copying a combined total of the files of the game software 70 which files belong to the first group 72a and the files of the patch data 80 which files belong to the first group 82a. This progress state may be expressed in the form of the progress bar 154 and the data size information 156 depicted in FIG. 10, for example. By viewing the progress state, the user can recognize a waiting time before the game can be started.

Incidentally, when the installation of the files of the game software 70 which files belong to the first group 72a and the files of the patch data 80 which files belong to the first group 82a is completed, the notifying section 116 makes pop-up display of information indicating the completion of the installation on the output device 4. The pop-up display of the information indicating the completion of the installation by the notifying section 116 can inform the user that the game can be played. Incidentally, the copy processing section ultimately copies all of the files of the game software 70 and the patch data 80 to the auxiliary storage device 2. However, as described also in the embodiment, the notifying section 116 does not need to notify the user that all of the files have been copied.

The present technology contains subject matter related to that disclosed in Japanese Priority Patent Application JP 2015-158432 filed in the Japan Patent Office on Aug. 10, 2015, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a download executing section downloading application software and patch data;
a progress state display section displaying a progress state of the downloading; and
an executing section executing an application by using the application software and the patch data;
the progress state display section displaying the progress state of the downloading of a combined total of the application software and the patch data.

2. The information processing device according to claim 1, wherein
the application software and the patch data each include a plurality of groups, one group of the patch data is associated with one group of the application software, and the executing section can start the application after the download executing section downloads a file belonging to a first group of the application software and downloads a file belonging to a first group of the patch data, and
the progress state display section displays the progress state of the downloading of the combined total of the file of the application software, the file belonging to the first group, and the file of the patch data, the file belonging to the first group.

3. The information processing device according to claim 2, wherein
after completion of the downloading of the file of the application software, the file belonging to the first group, and the file of the patch data, the file belonging to the first group, or completion of installation of the file of the application software, the file belonging to the first group, and the file of the patch data, the file belonging to the first group, the progress state display section displays information indicating the completion in a first display region.

4. The information processing device according to claim 3, wherein
the progress state display section displays, in a second display region, the progress state of the downloading of a combined total of files belonging to a second group and subsequent groups of the application software and files belonging to a second group and subsequent groups of the patch data.

5. The information processing device according to claim 4, wherein
the progress state display section displays, in the second display region, the downloading progress state enabling a comparison of an amount of already downloaded data with a total amount of data of the application software and the patch data.

6. The information processing device according to claim 3, wherein
the first display region displaying the information indicating the completion is configured to give an instruction to start the application when selected by a user.

7. The information processing device according to claim 2, further comprising a notifying section that, after completion of the downloading of the file of the application software, the file belonging to the first group, and the file of the patch data, the file belonging to the first group, or completion of installation of the file of the application software, the file belonging to the first group, and the file of the patch data, the file belonging to the first group, makes pop-up display of information indicating the completion on a screen displaying the progress state of the downloading or another screen,
wherein even after completion of the downloading of all of files of the application software and the patch data or completion of installation of all of the files of the application software and the patch data, the notifying section does not make pop-up display of information indicating the completion.

8. A method of displaying a download progress state, the method comprising:
downloading application software and patch data; and
displaying a progress state of the downloading;
the displaying of the progress state displaying the progress state of the downloading of a combined total of the application software and the patch data.

9. A program for a computer, comprising:
downloading application software and patch data; and
displaying a progress state of the downloading;
the progress state displaying including
displaying the progress state of the downloading of a combined total of the application software and the patch data.
